(19) United States
(12) Patent Application Publication
(10) Pub. No.: US 2012/0311050 A1
(43) Pub. Date: Dec. 6, 2012

(54) USER BROWSING EXPERIENCE

(76) Inventors: Eitan Lev, Even Yehuda (IL); Mordechai Teicher, Hod Hasharon (IL)

(21) Appl. No.: 13/470,481

(22) Filed: May 14, 2012

Related U.S. Application Data
(60) Provisional application No. 61/491,910, filed on Jun. 1, 2011.

(51) Int. Cl. G06F 15/16

(52) U.S. Cl. 709/206

(57) ABSTRACT

A method for automatically providing a computer application to a user connected to a network, based on the user's searching. A software agent embedded in the user's computer monitors message traffic between a browser and a network search server. The agent detects a search query from the browser to the search server as well as a search result from the search server. The agent reports search parameters to a designated network server, which selects an application relevant to the user's search and automatically installs the application title on the computer. The full application can also be installed for local execution. The application is launched upon installation and a popup window demonstrates the application to the user. An icon representing the application can also be automatically installed on a toolbar in the browser window, so the user can benefit from running the application even when not actively searching on the network.

### CROSS REFERENCE TO RELATED APPLICATIONS

This application claims benefit of U.S. Provisional Patent Application Ser. No. 61/491,910, filed Jun. 1, 2011, entitled “Method for improving user browsing experience”, the disclosure of which is hereby incorporated by reference and the priority of which is hereby claimed pursuant to 37 CFR 1.78(a) (4) and (5)(i).

### FIELD OF THE INVENTION

The present invention relates to networked computer applications and, more particularly, to a method for automatically providing application functionalities to a computer user based on network searching by the user.

### BACKGROUND OF THE INVENTION

Computer applications provide users with a great variety of functionalities, having a scope that ranges from general-purpose to highly-specialized. A challenge to vendors who offer specific applications is identifying and reaching users who would benefit from the advantages offered by those applications. Vendors want to make it easy for computer users to learn about their applications and to install those applications on their computers. A challenge to the users is managing the large number of computer applications on their computers. Users want it to be easy to access and employ useful applications.

Networks, such as the Internet, provide increased opportunity to vendors for reaching interested users and distributing computer applications to those users. In addition, computer applications that are compatible with networks offer additional valuable functionalities to the users.

The term “computer” herein denotes any device or apparatus capable of executing data processing instructions, non-limiting examples of which include: personal computers; workstations; embedded systems; processors, terminals; personal digital appliances (PDA); communications and telephonic devices, such as mobile telephones; and memory devices, storage devices, interface devices, smart cards and tags, security devices, and security tokens having data processing and/or programmable capabilities. The term “computer environment” herein denotes any collection of one or more computers or like devices which operate in conjunction, such as networked computers.

The term “computer application” herein denotes a collection of functionalities offered to a computer user. Non-limiting examples of applications include: a word processor; an electronic calendar; and a computer game. A computer application is embodied in a computer program or computer software which provides the useful services to the computer user. An application may be offered for more than one type of computer, in which case the features and/or user interface may be adapted to the characteristics of the respective computers and still be considered the same application. As a non-limiting example, the user interface and features of a mobile telephone version of a particular word processor may offer a reduced set of functionalities in comparison to version for a desktop, yet be considered the same application. Usually, different versions of an application share the same application name, primary features, and ability to exchange data files among the respective computers.

For brevity, a computer application is also referred to herein an “application”. FIG. 1 conceptually illustrates the functional interface and organization of a prior-art computer application 101. Application 101 contains an application title 103, which is user-recognizable information that identifies an application to a user, and which also contains a computer-recognizable link 131 to application 101.

A computer can recognize link 131 and use link 131 to access all of application 101. Application title 103 has an application title name 133 and/or an application title icon 135, both of which are examples shown in the drawings as representative of application titles. An application title name is any linguistic representation serving to identify the application to a user. Likewise, an application title icon is any graphical representation serving to identify the application to a user.

Associated with application 101 is a set of functionalities 105, which provide useful services to the user and/or to third parties, non-limiting examples of which include service providers and vendors. Application 101 also includes executable code 107, which includes data and computer instructions for a computer or other processing device to carry out the processing which provides the functionalities, by executing executable code 107, or portions thereof. Application title 103 along with application title name 133 and application title icon 135 are logically connected via link 131 to application 101 along with functionalities 105 and executable code 107. The examples of applications, application titles, application title names, and application title icons used herein are non-limiting. In addition, all examples are fictitious and are intended to be representative of actual counterparts for the purpose of illustration.

Application title 103 is also shown as separate from application 101, because application title 103 can exist as a separate entity apart from other portions of application 101, notably executable code 107.

Application 101 is contained within a computer environment which is capable of executing executable code 107 to provide functionalities 105. As noted previously, a computer environment can also recognize link 131 of application title 103 to access and execute executable code 107. Non-limiting examples of such computer environments include computers, computer operating systems, and interconnected computing devices. Such a computer environment may include a local computer 109 which is physically-accessible to a user, as well as one or more remote servers 111 which are connected via respective active communication links 115 to a network 113, a non-limiting example of which is the Internet. Local computer 109 is also connected to network 113 via an active link 117, and thus computer 109 and servers 111 are able to communicate among one another over network 113. The terms “local” and “remote” with reference to a device pertain to the physical accessibility of the user to the device. For example, local computer 109 may be a personal computer belonging to the user. Remote servers 111 may be servers of service providers and/or vendors.

Application 101 may reside, for example, entirely within local computer 109. Alternatively, for example, executable code 107 may reside in one or more servers 111 for remote execution, and provide services and functionalities to the user over network links 115 and 117.

In addition to being part of application 101, application title 103 is also contained within local computer 109. The user causes computer 109 to execute application 101 by any of various methods involving the selection of application title 103 via application title name 133 or application title icon 135. Such methods include, but are not limited to: selecting application title 103 and calling an open or run command from a menu; or clicking, double-clicking, or tapping application title 103, or by using a keyboard “shortcut” command associated with application title 103. An application title is said to be “opened” or “run” by such actions. In functional terms, the operating system of computer 109 recognizes link 131 and interprets the user's action to initiate the execution of executable code 107 in computer 109, loading executable code 107 into the executable memory of computer 109, if necessary.

Although application title 103 is contained within computer 109, it is not necessary for application 101 to be completely contained within computer 109. Application 101 may also be contained in one or more of remote servers 111. So long as link 131 accurately identifies the location of application 101 in a manner that allows the operating system of computer 109 to properly initiate execution of executable code 107, application 101 need not be completely contained in local computer 109. Alternatively, application 101 may be distributed among several devices; for example, the user interface functionalities and executable code of application 101 may be located in local computer 109, and data processing functionalities and executable code of application 101 may be located in remote servers 111.

It is also noted that specific computer applications are generally embodied in self-contained instances, each of which is able to function independently in suitable computer environments. References to particular applications in the descriptions herein are to specific instances of the respective particular applications, and it is understood that other instances of the same applications may simultaneously exist and be operational in other computer environments and/or divisions thereof. Similarly, references herein to specific application titles and their components are to specific instances of the respective application titles.

The term “browser” herein denotes a computer program or computer software running on a local computer which provides an interface to a user for accessing data and functionalities provided on remote servers over a network. FIG. 2 illustrates the principal user interface features of a typical prior-art browser window 201 for the Internet “World Wide Web”. A title bar 203 indicates a name 219 of the browser program, and a specific server or domain 217 (if any) of the Web that is being browsed. A menu bar 205 provides user access to browser functionalities, and a native toolbar 207 provides quick access to selected user browser functionalities. An add-in toolbar 209 provides quick access to selected functionalities which the user has added to browser window 201, and features exemplary application title icons 211 and 213. (An “add-in” is a small computer program and/or the user interface features thereof which is installed into a larger computer program, in this case a browser. Add-ins are also variously called “add-ons” and “plug-ins”.) A status bar 215 notifies the user of the present operational status of browser window 201.

It would be advantageous to both vendors and users alike to have an efficient way for users to easily obtain additional applications that provide functionalities which are particularly relevant to their network browsing, and which would be easy for users to install in their computers and use. This goal is met by the present invention.

### SUMMARY OF THE INVENTION

The present invention provides methods for automatically offering applications to a computer user, which provide functionalities relevant to the user's network browsing and searching. The application titles are installed automatically and unobtrusively in the user's computer, making it easy for the user to access their respective functionalities. In some cases, the executable code of an application is also installed, so that the operation of the application is network-independent. In other cases, an application title links to the application on a remote server, requiring a network connection to access the functionalities of the application.

In an embodiment of the present invention, a software agent in a local computer employed by the user is associated with a toolbar attached to a network browser program installed in the computer. In a further embodiment, the software agent is installed as an add-in of the browser. In another embodiment, the software agent runs in background mode, monitoring network communications with the capability of exchanging messages with the user through the browser and/or through other message windows. The agent monitors network traffic between the local computer and remote servers, particularly regarding the sending of search queries and the receiving of search results. When the agent detects messages related to outgoing search queries and/or incoming search results, a reporting message is sent by the agent to a designated server along with the parameters of the search query and/or the search results. In response, the designated server may select one or more applications with functionalities related to the search query and/or search results, and then install the selected application title in the user's local computer.

In an embodiment of the present invention, the application title is placed on a toolbar in the user's browser, in the form of an application title icon. In another embodiment, the application title appears in a drop-down list from the toolbar, rather than as a separate icon on the toolbar itself. In another embodiment, the application title is displayed in a text list or in a drop-down list or other window according to the local computer's operating system. In a further embodiment of the present invention, the user decides which form of link to employ.

To show the user the benefits of the application, in another embodiment the application is run when installation is complete, and the results of running the application are shown in a popup window.

Therefore, according to the present invention there is provided a method for improving the browsing experience of a user of a local computer connected to a network, the method including: (a) executing, by the local computer, instructions of a software agent contained therein, for monitoring messages exchanged between a browser in the local computer and servers connected to the network; (b) detecting, by the monitoring, at least one message of the following messages: (1) a message that includes a search query; (2) a message that includes a search result; (c) sending a reporting message derived from the at least one message to a predefined server on the network; (d) receiving, from the predefined server, an application title related to an application, wherein the application was selected by the predefined server in response to the reporting message; (e) automatically opening the application title to cause the application to execute; and (f) automatically storing the application title in a nonvolatile storage device of the local computer, for allowing the user to subsequently execute the application irrespective of detecting the at least one message.

### BRIEF DESCRIPTION OF THE DRAWINGS

The present invention will be more fully understood from the following detailed description of the embodiments thereof, taken together with the drawings in which:

FIG. 1 conceptually illustrates the functional interface and organization of a prior-art computer application.

FIG. 2 illustrates the principal user interface features of a typical prior-art Web browser interface window.

FIG. 3 conceptually illustrates the functional interface and organization of a toolbar and agent according to an embodiment of the present invention.

FIG. 4 illustrates the user interface of a Web browser window that includes a toolbar according to an embodiment of the present invention.

FIG. 5 conceptually illustrates the communication and data paths among a computer and network servers according to an embodiment of the present invention.

FIG. 6 illustrates the user interface of a Web browser window that features a popup window of an application executed according to an embodiment of the present invention.

FIG. 7 illustrates an example of an addition of an application title to the toolbar according to an embodiment of the present invention.

FIG. 8 illustrates an addition of a drop-down list to the toolbar according to another embodiment of the present invention.

FIG. 9 illustrates an example of a drop-down list of the toolbar of FIG. 8.

FIG. 10 is a flowchart illustrating the steps of a method according to an embodiment of the present invention.

### DETAILED DESCRIPTION OF THE EMBODIMENTS

The principles and operation of methods according to the present invention may be understood with reference to the drawings and the accompanying description.

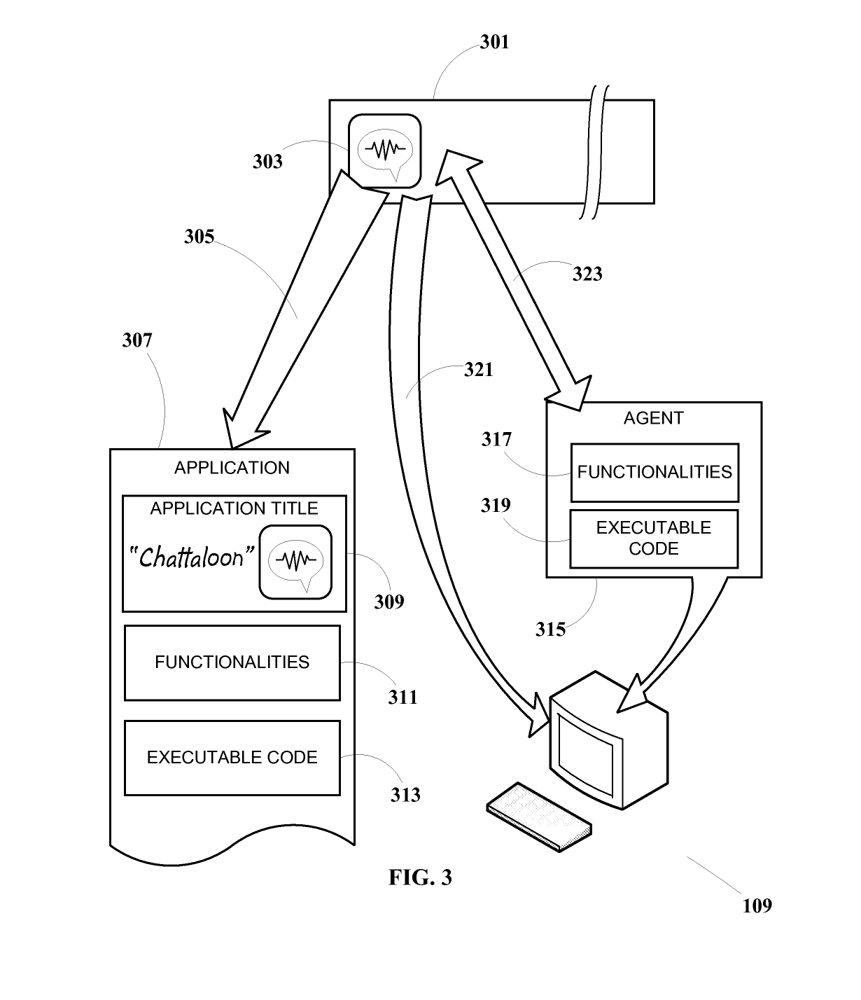

FIG. 3 conceptually illustrates the functional interface and organization of a toolbar 301 and an agent 315 according to an embodiment of the present invention. Agent 315 is installed as a software program in local computer 109 of the user. Agent 315 has a set of functionalities 317, as will be described herein, and executable code 319, which includes data and computer instructions for a computer 109 to carry out the processing which provides functionalities 317, by executing executable code 319, or portions thereof.

In embodiments of the present invention, agent 315 is completely contained within local computer 109. That is, in such embodiments agent 315 does not require a connection to the network or external computing resources to operate. Also, agent 315 does not feature a user-visible application title, because the user does not have to issue any commands for computer 109 to run agent 315. In some embodiments of the present invention, agent 315 is launched automatically upon startup of browser 201. In other embodiments, agent 315 is launched automatically upon startup of computer 109.

Agent 315 is associated with, or forms part of, toolbar 301 via a link 323. Toolbar 301 is also embedded within local computer 109 via a link 321, as will be discussed in further detail below.

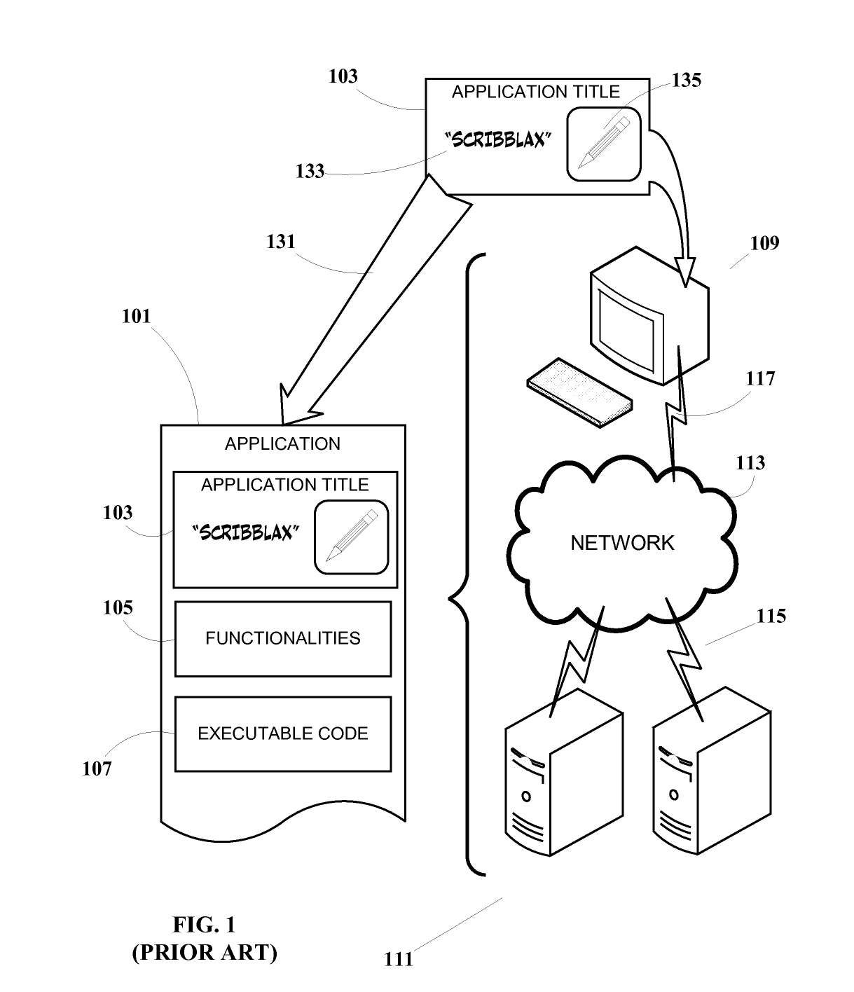

On toolbar 301 is an exemplary application title icon 303, which is representative of toolbar application title icons in general. As before, application title icon 303 has a link 305 to application 307. Application 307 has an application title 309, functionalities 311, and executable code 313. As illustrated in FIG. 1 for general cases, application 307 may reside entirely within local computer 109 or alternatively, executable code 313 may reside in remote servers connected to computer 109 via suitable network links.

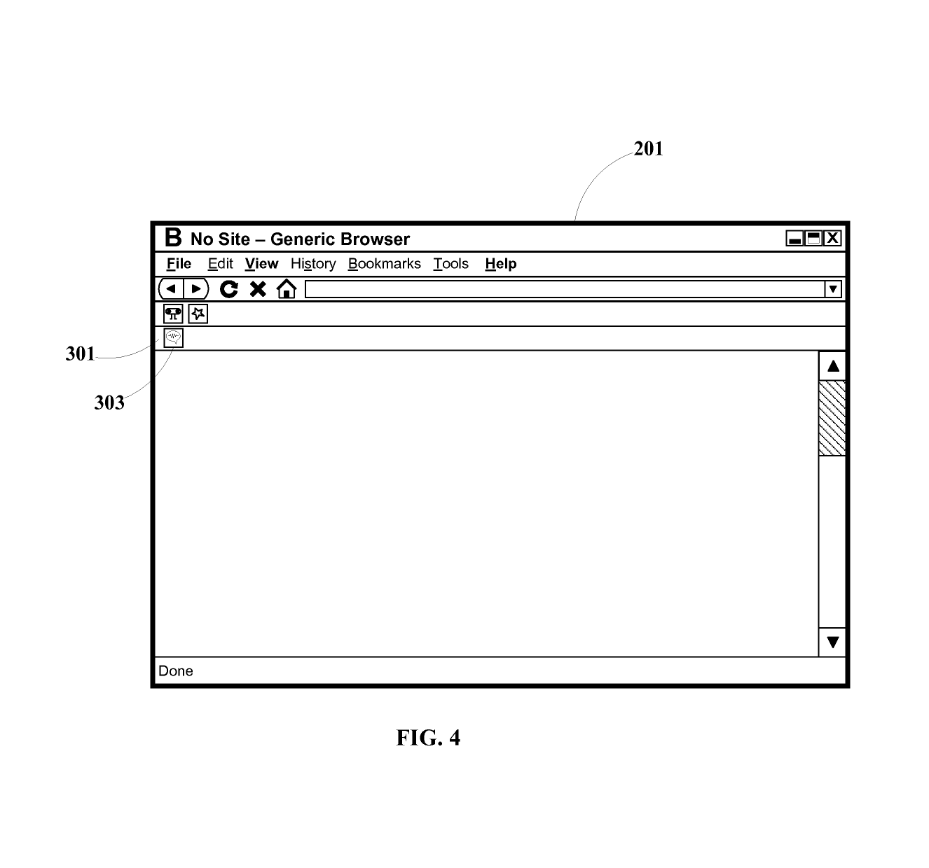

FIG. 4 illustrates the user interface of browser window 201 when incorporating toolbar 301 with application title icon 303 according to an embodiment of the present invention.

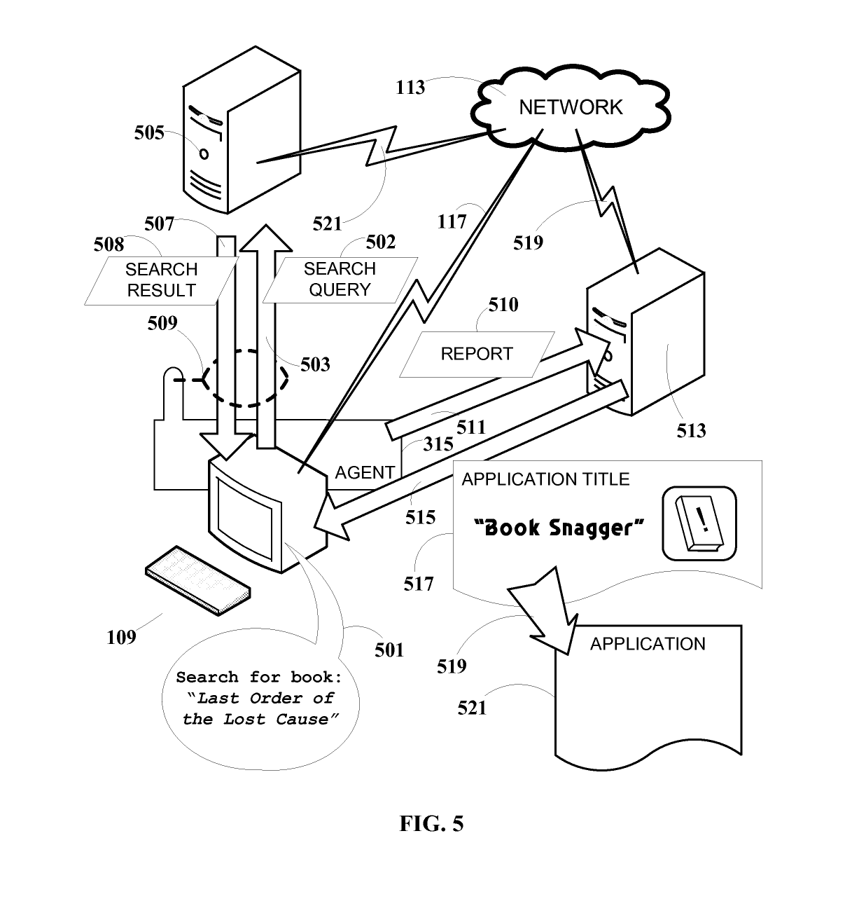

FIG. 5 conceptually illustrates the operation of logical communication and data paths 503, 507, 511, and 515 connecting local computer 109, a search server 505 and a designated server 513 over network 113 to provide an application title 517 to local computer 109 according to an embodiment of the present invention. Physically, the communication and data paths include network 113, link 117, and links 519 and 521, but the operation according to the embodiment of the present invention may be better understood in terms of logical communication and data paths 503, 507, 511, and 515.

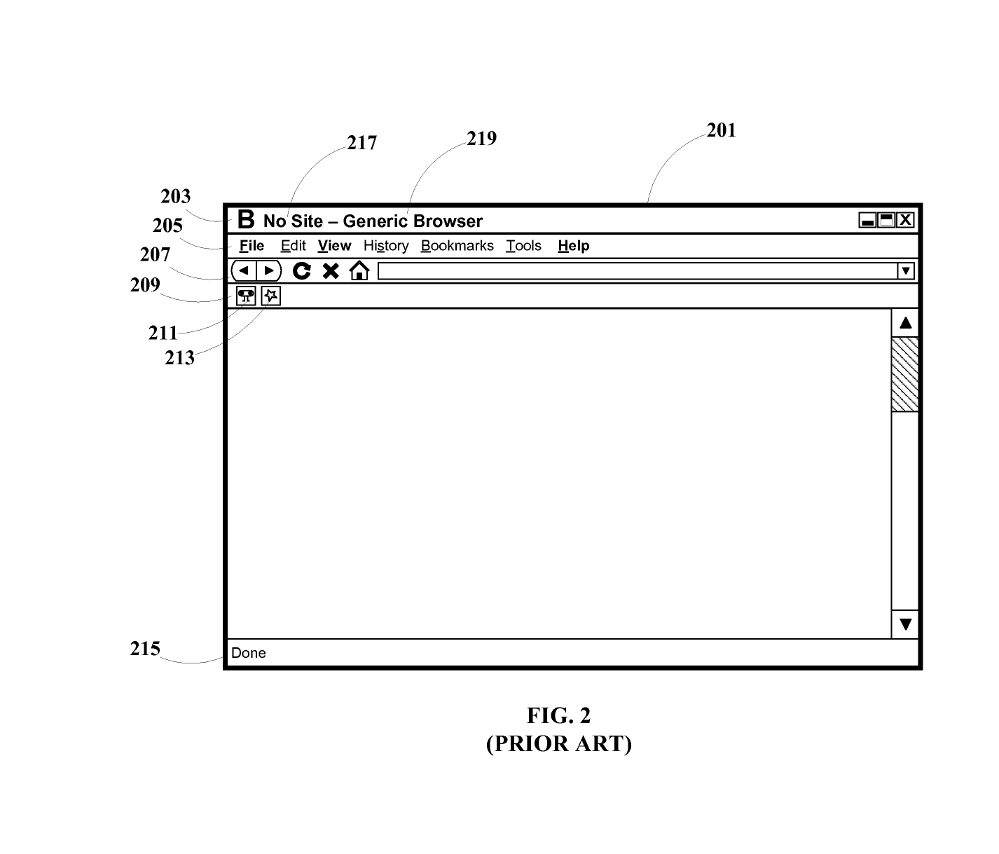

In the non-limiting example shown in FIG. 5, the user employs a browser interface (such as browser window 204 in FIGS. 2 and 4) to create a network search request 501 for a particular book, by specifying the title of the book in search request 501.

The term “search request” herein denotes a character string written or created by the user in natural human language, typically via typing one or more search words or search phrases into an interactive text box. In the non-limiting example of FIG. 5, search request 501 could appear as the character string, “book “last order of the lost cause””. The search word “book” is combined with the search phrase ““last order of the lost cause”” (in double quotes “ . . . ” for specifying a phrase) to show that both the search word and the search phrase must be present in a result. In this example, the search word and the search phrase are each parameters of the requested search.

The term “search query” herein denotes a character string containing at least one search parameter of a search request, which is expressed in formalized syntactic form, typically by a computer program. In the non-limiting example of FIG. 5, a syntactically-formalized search query based on search request 501 could appear as the character string, “search?q=book+“last+order+of+the+lost+cause””. This search query contains the search parameters as well as symbols which indicate how they are logically combined in the search. The term “search query message” herein denotes a message sent over a network, wherein the message contains a search query. According to an embodiment of the present invention, the user interacts with search server 505 via a browser interface (such as browser window 201 in FIGS. 2 and 4) of a browser having a logical connection with search server 505, for exchanging messages over network 113.

A search query message 502 based on search request 501 is sent via logical path 503 to search server 505, and search server 505 returns a search result message 508 via logical path 507 to computer 109. Search query message 502 contains parameters of a search based on search request 501, which in this non-limiting example includes the user's intention to request information on a book by a specific book title. Thus, the parameters in search query message 502 include the search term “book” along with the book's title.

Typically, search result message 508 include a set of network pointers, in the form of Universal Resource Locators (URL's) which give the locations on the network of resources, such as Web pages, which feature or cite the information indicated in search query message 502.

Agent 315 employs a monitor 509 to watch message traffic over logical paths 503 and 507. In an embodiment of the present invention, agent 315 detects search query message 502 and sends a report message 510 via logical path 511 to designated server 513. Designated server 513 has been pre-assigned to receive report messages such as report message 510, which contains at least one parameter of search query message 502 and/or at least one parameter derived from parameters of search query message 502.

In another embodiment of the present invention, agent 315 detects search result message 508 and sends a report message 510 via logical path 511 to designated server 513. According to this embodiment, agent 315 may benefit from sophisticated processing performed by search server 505. In a non-limiting example, a search query message might include the parameter “high definition camera”. Search server 505 might then process this search query message to include in the search result message a product referred to as an “HD camera”. By examining the search result message, agent 315 may thereby obtain additional search parameters related to the user's search request 501.

According to an embodiment of the present invention, in response to receiving report message 510, designated server 513 sends, via logical path 515, an application title 517 to computer 109. Application title 517 is logically connected to an application 521 via a link 519 (as previously detailed). Application 521 is selected by designated server 513 as being related to search request 501 and therefore being of possible interest to the user. In another embodiment, designated server 513 sends complete application 521 to computer 109.

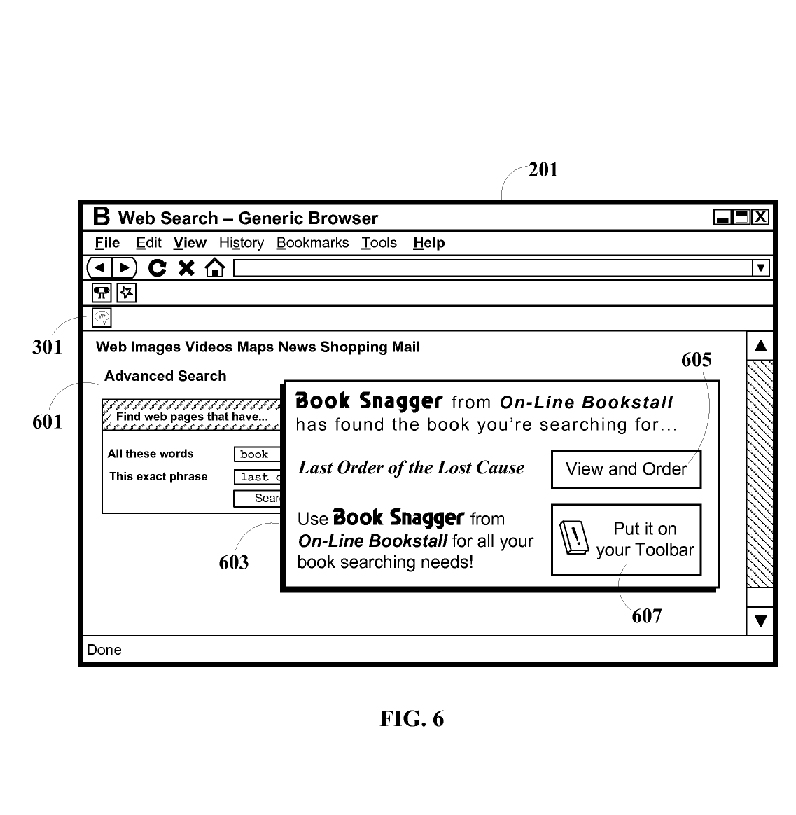

In an embodiment of the present invention, after application title 517 is sent to computer 109, application 521 is executed. FIG. 6 illustrates browser interface window 201 that features a pane 601 for entering a user search request, and a popup window 603 of application 521 (FIG. 5), after the linked application is executed. Popup window 603 is generated and displayed by application 521.

In this non-limiting example, popup window 603 features a button 605 and a button 607 for user interaction. Button 607 allows the user to have application title 517 put onto toolbar 301, according to an embodiment of the present invention.

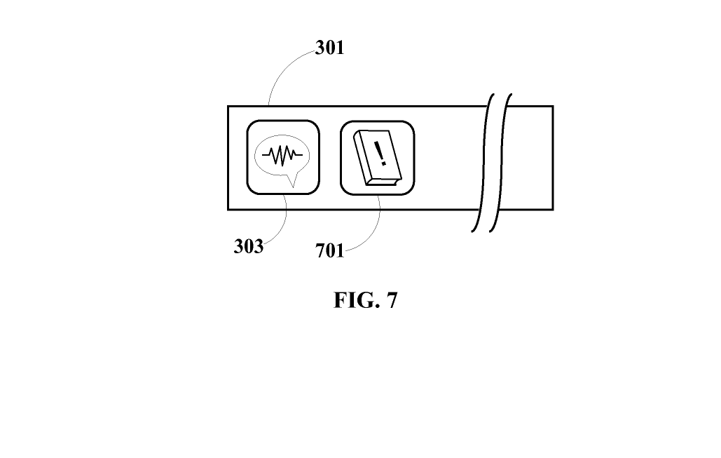

FIG. 7 illustrates toolbar 301 with an application title icon 701 corresponding to application title 517, according to the embodiment of the present invention referenced above in the discussion of FIG. 6. In this non-limiting example of the embodiment, the user has pressed button 607 to place application title icon 701 on toolbar 301.

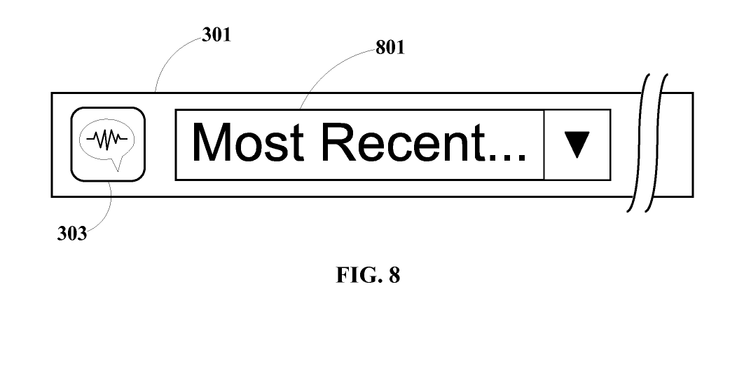

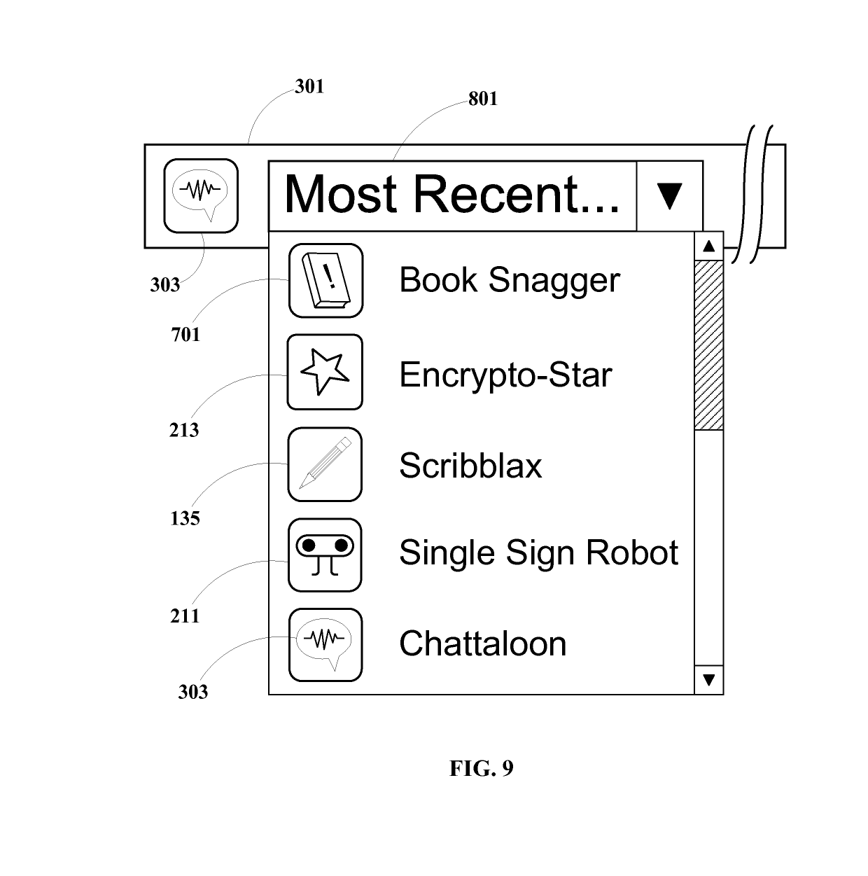

FIG. 8 illustrates another embodiment of the present invention, which is an alternative to the embodiment referenced above in the discussions of FIG. 6 and FIG. 7. In some cases, it may be felt by the user that having the application title or even the application title icon on the toolbar is obtrusive. FIG. 8 therefore illustrates an alternative embodiment, wherein toolbar 301 contains a “Most Recently Used” dropdown box 801. In the normal state, dropdown box 801 is compacted as shown. In FIG. 9, however, dropdown box 801 is expanded, showing all recently-used applications, including application title icon 701, from which the user may make a selection. When dropdown box 801 is compacted as shown in FIG. 8, application title icon 701 is still accessible via the drop-down box, but it remains hidden and unobtrusive.

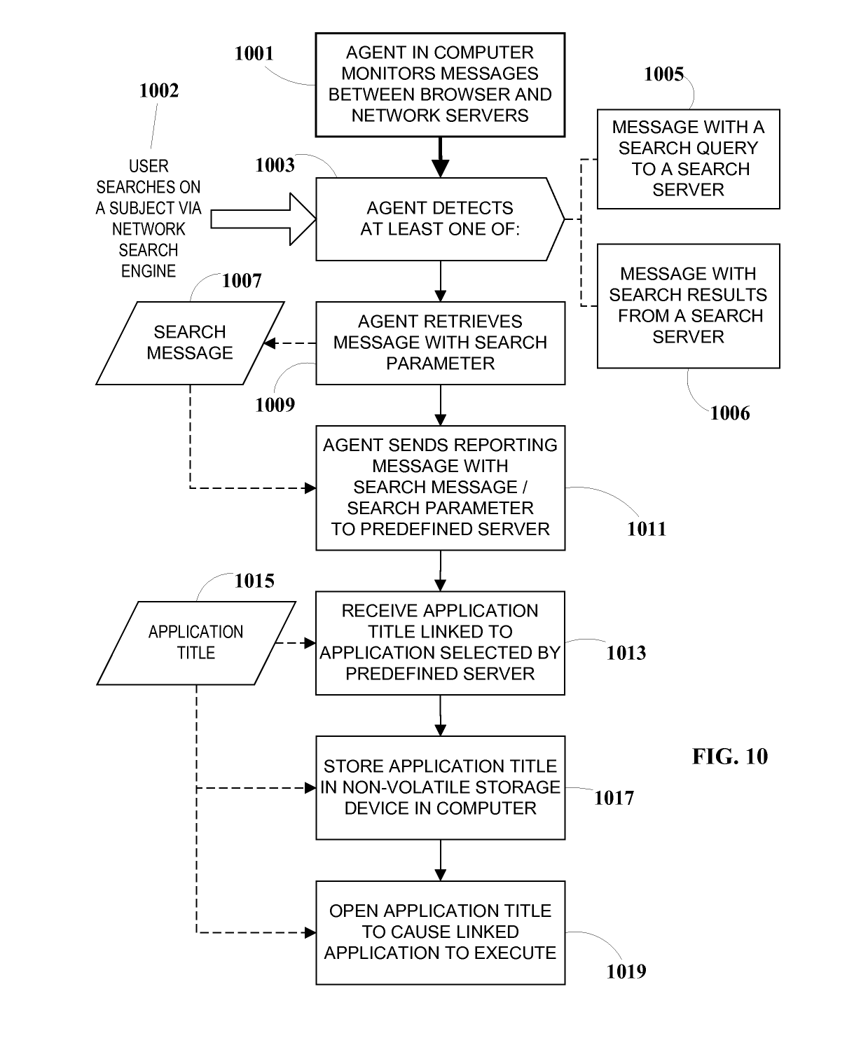

FIG. 10 is a flowchart illustrating the steps of a method according to an embodiment of the present invention. This method is carried out by a processing device in a local computer, such as computer 109 (FIGS. 1, 3, and 5), employing a software agent, such as agent 315 (FIGS. 3 and 5), having program instructions executed by the processing device. In a step 1001 the agent in the computer continually monitors messages exchanged between a browser and remote network servers. In an event 1002 a user employing the browser initiates a search request on a subject via a network search engine. Subsequently, in a step 1003, the agent detects at least one of the following message conditions: a message condition 1005 where a message with a search query was detected as sent to a search server; and/or a message condition 1006 where a message with a search result was detected as coming from a search server. In a step 1009, responsively to detecting at least one of the foregoing message conditions, the agent retrieves the detected message with a search parameter, and stores the message as stored data 1007. In a step 1011 the agent sends a reporting message to a predefined remote network server. According to an embodiment of the present invention, step 1011 includes the message with the search query; in other embodiments, step 1011 includes only a search query or only a search parameter.

In a step 1013, the computer receives an application title 1015 which is linked to an application selected by the designated server. In an embodiment of the present invention, the selection is made in response to the reporting message; in other embodiments, the selection is made in response a search query of the reporting message, a search parameter of the reporting message, or a search result of the reporting message. In a step 1017 application title 1015 is stored in a non-volatile storage device in the local computer, and in a step 1019 application title is opened, causing the linked application to execute. Step 1017 and step 1019 may be performed in either order or simultaneously.

A further embodiment of the invention provides a computer product for performing the above method and variants derived therefrom.

A computer product according to this embodiment includes a set of executable commands for a computer within tangible non-transient computer-readable data storage including, but not limited to: computer media of any kind, such as magnetic media and optical media; computer memory; semiconductor memory storage; flash memory storage; data storage devices and hardware components; and a computer or remote data storage devices on a communications network. The terms “perform”, “performing”, etc., and “run”, “running”, when used with reference to a computer product herein denote that when the executable commands within the computer product are executed, the computer product causes the computer to perform the predefined actions.

While the invention has been described with respect to a limited number of embodiments, it will be appreciated that many variations, modifications and other applications of the invention may be made.

What is claimed is:

1. A method for improving the browsing experience of a user of a local computer connected to a network, the method comprising:
executing, by the local computer, instructions of a software agent contained therein, for monitoring messages exchanged between a browser in the local computer and servers connected to the network;
detecting, by the monitoring, at least one message of the following messages:
a message that includes a search query, or
a message that includes a search result;
sending a reporting message derived from the at least one message to a predefined server on the network;
receiving, from the predefined server, an application title related to an application, wherein the application was selected by the predefined server in response to the reporting message;
automatically opening the application title to cause the application to execute; and
automatically storing the application title in a nonvolatile storage device of the local computer, for allowing the user to subsequently execute the application irrespective of detecting the at least one message.

2. The method of claim 1, wherein the reporting message contains the search query.

3. The method of claim 1, wherein the automatically opening the application title to cause the application to execute includes inputting the reporting message into the application.

4. The method of claim 1, wherein the application is a web program running on a remote server and interfacing with the user via the browser.

5. The method of claim 1, wherein the application runs on the local computer, and the receiving from the predefined server also includes receiving executable code of the application.

6. The method of claim 1, wherein the storing includes adding the application title to a toolbar of the browser.

7. The method of claim 1, wherein the storing includes adding the application title to a list of recently used applications.

8. A computer product comprising tangible non-transient data storage containing executable instructions, which instructions, when executed by a computer, cause the computer to perform:
monitoring messages exchanged between a browser in the local computer and servers connected to the network;
detecting, by the monitoring, at least one message of the following messages:
a message that includes a search query, or
a message that includes a search result;
sending a reporting message derived from the at least one message to a predefined server on the network;
receiving, from the predefined server, an application title related to an application, wherein the application was selected by the predefined server in response to the reporting message;
automatically opening the application title to cause the application to execute; and
automatically storing the application title in a nonvolatile storage device of the local computer, for allowing the user to subsequently execute the application irrespective of detecting the at least one message.

9. A system for improving the browsing experience of a user of a local computer connected to a network, the system comprising:
a pre-designated server connected to the network;
a software agent contained within the local computer, wherein the local agent is operative to perform:
monitoring messages exchanged between a browser in the local computer and at least one server connected to the network;
detecting, by the monitoring, at least one message of the following messages:
a message that includes a search query, or
a message that includes a search result;
responsively to the detecting, sending a reporting message derived from the at least one message to the pre-designated server;
receiving, from the pre-designated server, an application title related to an application;
opening the application title to cause the application to execute; and
storing the application title in a nonvolatile storage device of the local computer, for allowing the user to subsequently execute the application irrespective of detecting the at least one message; and
wherein the pre-designated server is operative to select the application in response to the reporting message from the software agent.

10. The system of claim 9, wherein the storing includes adding the application title to a toolbar of the browser.

11. The system of claim 9, wherein the storing includes adding the application title to a list of recently used applications.
